(19) United States
(12) Patent Application Publication
(10) Pub. No.: US 2007/0216508 A1
(43) Pub. Date: Sep. 20, 2007

(54) TRANSFORMER WITH ADJUSTABLE LEAKAGE INDUCTANCE AND DRIVING DEVICE USING THE SAME

(75) Inventors: CHIH-CHAN GER, Tu-Cheng (TW); YU-HSIANG LIAO, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/616,865

(22) Filed: Dec. 28, 2006

(30) Foreign Application Priority Data
Mar. 17, 2006 (TW) 95109255

(51) Int. Cl. H01F 27/30

(52) U.S. Cl. 336/198

(57) ABSTRACT

A transformer (50) with adjustable leakage inductance includes a first bobbin (525), a first winding (521), and a second winding (522). The first bobbin includes a first region (B1) and a second region (B2). The second winding includes a first coil portion (522a) and a second coil portion (522b). One of the first winding and the first coil portion of the second winding is wound around the first region of the first bobbin, and the other of the first winding and the first coil portion of the second winding is wound outside of the one wound around the first region of the first bobbin. The second coil portion of the second winding is wound around the second region of the first bobbin. In the invention, the leakage inductance of the transformer is adjustable via adjusting the number of the coils of the first coil portion and the second coil portion.

### BACKGROUND OF THE INVENTION

1. Field of the Invention

The present invention relates to transformers, and particularly to a transformer with an adjustable leakage inductance.

2. Description of Related Art

In an electronic device, one or more transformers are used for converting a received power signal to an appropriate signal to ensure the electronic device to work normally. Generally, each transformer has leakage inductance more or less due to a primary winding not fully coupling to the secondary winding. Therefore, on one hand, it is needed to decrease the leakage inductance to save energy to increase conversion efficiency of the transformer. On the other hand, the leakage inductance can be used to meet resonance requirements. Thus, how to balance the need for saving energy and obtain suitable leakage inductance of the transformer to meet electromagnetic requirements to gain a good resonance is an important point.

FIG. 8 shows a cross sectional view of a conventional transformer 100. The conventional transformer 100 includes a bobbin 10, a first winding 11, a second winding 12, an insulating tape 13, and a core assembly (not shown). The core assembly is inserted into a hollow portion 110a of the bobbin 10. The first winding 11 is wound around the bobbin 10. The second winding 12 is wound outside of the first winding 11, which is insulated from the first winding 11 with the insulating tape 13. Therefore, the first winding 11 and the second winding 12 form a layered structure, which provides a good coupling ratio but little leakage inductance.

A cross sectional view of another conventional transformer 200 is shown in FIG. 9. The transformer 200 includes a bobbin 20, a first winding 21, a second winding 22, a plurality of isolating walls 24, and a core assembly (not shown). A hollow portion 20a of the bobbin 20 is provided to receive the core assembly. The bobbin 20 is divided into a primary side region b1, a secondary side region b2, and an empty coiling region b3 formed by two isolating walls 24. In addition, the secondary side region b2 is divided into a plurality of coiling regions by the isolating walls 24. The first winding 21 is wound around the primary side region b1, and the second winding 22 is wound around the secondary side region b2. Therefore, the first winding 21 and the second winding 22 form a side-by-side structure, which provides greater leakage inductance but a poor coupling ratio.

Therefore, the conventional transformer 100 has less leakage inductance, but does not achieve a very good resonance response, and the conventional transformer 200 has a greater leakage inductance, but lower efficiency. In addition, the leakage inductances of the transformer 100 and 200 are fixed, so no fine-tuning can be accomplished to suit needs. One solution for changing the leakage inductance is changing the coiling structure, which is inconvenient.

### SUMMARY OF THE INVENTION

One aspect of the present invention provides a transformer with an adjustable leakage inductance, which includes a first bobbin, a first winding, and a second winding. The first bobbin includes a first region and a second region. The second winding includes a first coil portion and a second coil portion. One of the first winding and the first coil portion of the second winding is wound around the first region of the first bobbin, and the other of the first winding and the first coil portion of the second winding is wound outside of the one wound around the first region of the first bobbin. The second coil portion of the second winding is wound around the second region of the first bobbin.

Another aspect of the present invention provides a driving device for driving a light source module comprising a plurality of light sources. The driving device includes a converter circuit, a driving switch circuit, a transformer circuit, and a PWM controller. The converter circuit converts a received power signal to a direct current signal. The driving switch circuit is connected to the converter circuit, for converting the direct current signal to an alternating current signal. The transformer circuit is connected between the driving switch circuit and the light source module, for converting the alternating current signal to an appropriate alternating current signal, and includes a transformer with an adjustable leakage inductance. The transformer includes a first bobbin, a first winding, and a second winding. The first bobbin includes a first region and a second region. The second winding includes a first coil portion and a second coil portion. One of the first winding and the first coil portion of the second winding is wound around the first region of the first bobbin, and the other of the first winding and the first coil portion of the second winding is wound outside of the one wound around the first region of the first bobbin. The second coil portion of the second winding is wound around the second region of the first bobbin. The PWM controller is connected to the driving switch circuit, for controlling the alternating current signal output from the driving switch.

Other advantages and novel features will become more apparent from the following detailed description when taken in conjunction with the accompanying drawings, in which:

### BRIEF DESCRIPTION OF THE DRAWINGS

FIG. 1 is a block diagram of a driving device in accordance with an exemplary embodiment of the present invention;

FIG. 2 is a block diagram of a driving device in accordance with another exemplary embodiment of the present invention;

FIG. 3a is an isometric, disassembled view of a transformer with an adjustable leakage inductance in accordance with a first embodiment of the present invention;

FIG. 3b is a cross-sectional view along a line Vb-Vb of FIG. 3a;

FIG. 4a is an isometric, disassembled view of a transformer with an adjustable leakage inductance in accordance with a second embodiment of the present invention;

FIG. 4b is a cross-sectional view along line VIb-VIb of FIG. 4a;

FIG. 4c is a cross-sectional view along line VIb-VIb of FIG. 4a;

FIG. 4d is a partially enlarged view along VId of FIG. 4a;

FIG. 5a is an isometric, disassembled view of a transformer with an adjustable leakage inductance in accordance with a third embodiment of the present invention;

FIG. 5b is a cross-sectional view along line VIIb-VIIb of FIG. 5a;

FIG. 6a is an isometric, disassembled view of a transformer with an adjustable leakage inductance in accordance with a fourth embodiment of the present invention;

FIG. 6b is a cross-sectional view along line VIIIb-VIIIb of FIG. 6a;

FIGS. 7a, 7b, and 7c are elevational views of a core assembly of transformer with an adjustable leakage inductance in accordance with the present invention;

FIG. 8 is a cross-sectional view of a conventional transformer; and

FIG. 9 is a cross-sectional view of another conventional transformer.

### DETAILED DESCRIPTION OF THE INVENTION

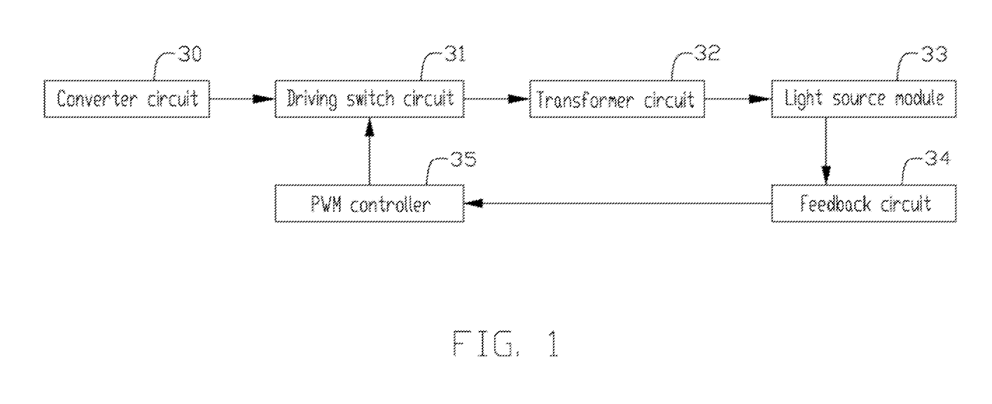

FIG. 1 shows a block diagram of a driving device in accordance with an exemplary embodiment of the present invention. The driving device for driving a light source module 33 includes a converter circuit 30, a driving switch circuit 31, a transformer circuit 32, a feedback circuit 34, and a PWM controller 35. The light source module 33 includes a plurality of light sources.

The converter circuit 30 converts a received power signal to a direct current (DC) signal. The driving switch circuit 31 is connected to the converter circuit 30, and is used for converting the DC signal to an alternating current (AC) signal. The transformer circuit 32 is connected between the driving switch circuit 31 and the light source module 33, for converting the AC signal to an appropriate AC signal to drive the light source module 33. In the exemplary embodiment, the AC signal output from the driving switch circuit 31 is a rectangular-wave signal, and the AC signal output from the transformer circuit 32 is a sine-wave signal. The feedback circuit 34 is connected between the light source module 33 and the PWM controller 35, for feeding back current flowing through the light source module 33 to the PWM controller 35. The PWM controller 35 is connected between the feedback circuit 34 and the driving switch circuit 31, for controlling the AC signal output from the driving switch circuit 31.

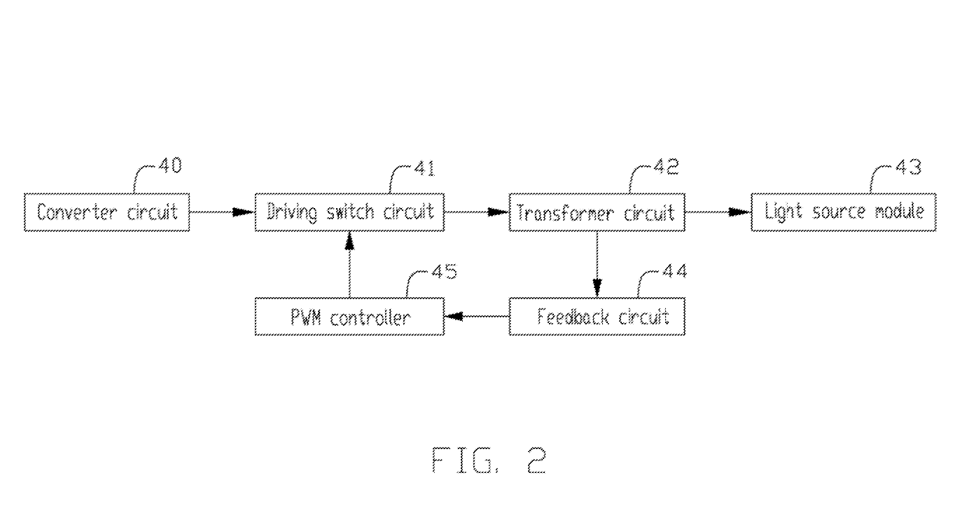

FIG. 2 shows a block diagram of a driving device in accordance with another exemplary embodiment of the present invention. The driving device shown in FIG. 2 is substantially the same as that of FIG. 1, except that the feedback circuit 44 is connected between the transformer circuit 42 and the PWM controller 45, for feeding back current flowing through the light source module 43 to the PWM controller 45. The transformer circuits 32 and 42 shown in FIG. 1 and FIG. 2 include a transformer with an adjustable leakage inductance.

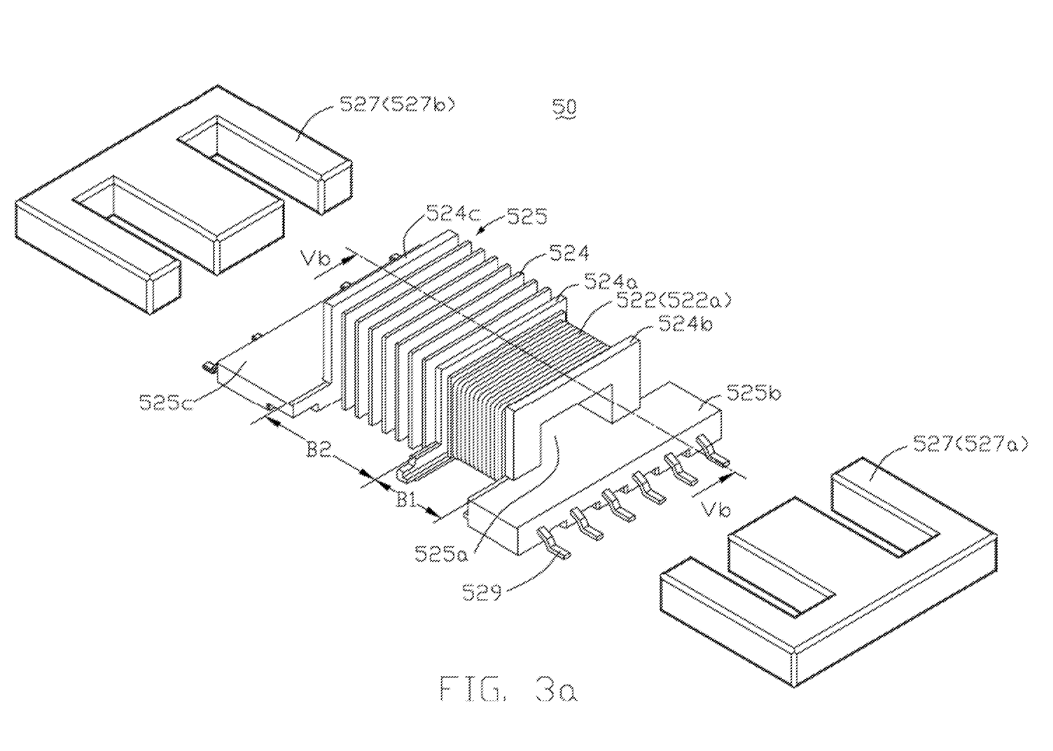

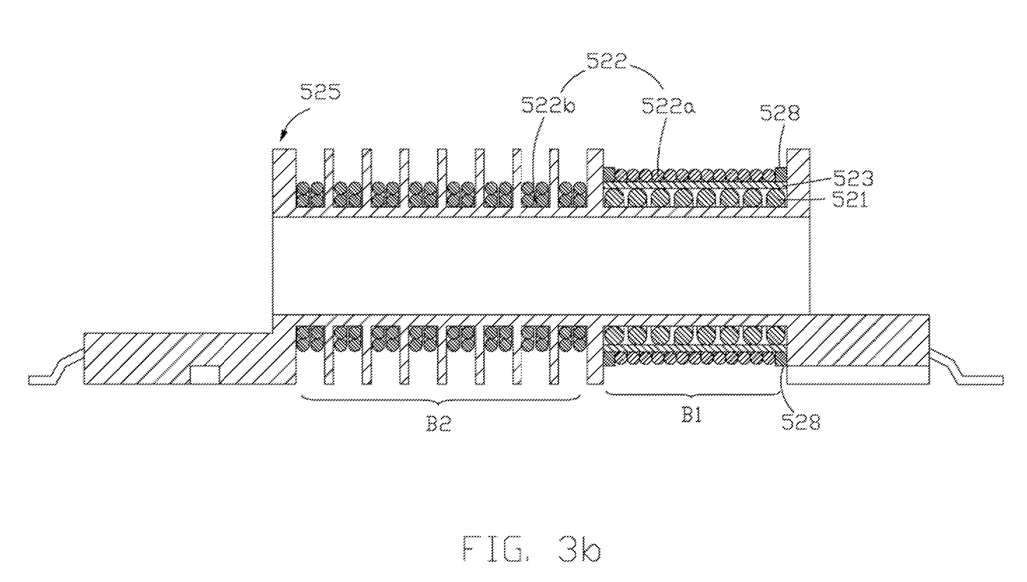

FIG. 3a shows an isometric, disassembled view of a transformer 50 with an adjustable leakage inductance in accordance with a first embodiment of the present invention, and FIG. 3b shows a cross-section view along a line Vb-Vb of FIG. 3a. The transformer 50 includes a bobbin 525, a first winding 521, a second winding 522, and a core assembly 527. In the exemplary embodiment, the second winding 522 includes a first coil portion 522a and a second coil portion 522b. The bobbin 525 has a plurality of isolating walls 524, which is divided into a first region B1 and a second region B2 by one isolating wall 524a. The first region B1 is used for winding the first winding and the first coil portion 522a of the second winding 522 around it, and the second region B2 is used for winding the second coil portion 522b of the second winding 522 around it.

In the exemplary embodiment, the bobbin 525 has a hollow portion 525a, a first base 525b, and a second base 525c. The first base 525b is near the first region B1 of the bobbin 525, and the second base 525c is near the second region B2 of the bobbin 525. In addition, a plurality of pins 529 are respectively disposed at the first base 525b and the second base 525c, for electrically connecting the transformer 50 to a circuit board (not shown). In the exemplary embodiment, the isolating wall 524b is at the same side as the first base 525b, and the isolating wall 524c is at the same side as the second base 525c. Thicknesses of the isolating wall 524b and the isolating wall 524c are larger than that of the isolating wall 524a, which enhance a rigidity of the transformer 50. Similarly, a thickness of the isolating wall 524a is also larger than that of the other isolating walls 524 (except the isolating wall 524b and the isolating wall 524c), which can enhance voltage tolerances of the transformer 50.

The core assembly 527 includes a first core 527a and a second core 527b. The first core 527a and the second core 527b are inserted into the hollow portion 525a of the bobbin 525, for forming magnetic loops. In the exemplary embodiment, the core assembly 527 includes two E-shaped cores made of highly conductive magnetic materials.

Referring to FIG. 3b, the first coil portion 522a of the second winding 522 is wound outside the first wind 521 and both are wound around the first region B1 of the bobbin 525. In the exemplary embodiment, the first winding 521 and the first coil portion 522a of the second winding 522 are insulated with an insulating layer 523 therebetween. In this embodiment, the insulating layer 523 is an insulating tape. The second coil portion 522b of the second winding 522 is wound around the second region B2. In alternative exemplary embodiments, the first winding 521 can be wound outside the first coil portion 522a of the second winding 522. That is, one of the first winding 521 and the first coil portion 522a of the second winding 522 is wound around the first region B1 of the first bobbin 525, and the other of the first winding 521 and the first coil portion 522a of the second winding 522 is wound outside of the one wound around the first region B1 of the first bobbin 525.

The transformer 50 further includes at least a pair of margin tapes 528 wound around the insulating layer 523. In the exemplary embodiment, the margin tapes 528 are also insulating tapes. Due to the margin tapes 528, a length of a coiling region of the first coil portion 522a is shorter than that of the first winding 521. In this way, the voltage tolerance of the transformer 525 is increased. The second region B2 of the bobbin 525 is divided into a plurality of coiling regions by the isolating walls 524. Thus, arcing does not occur when high voltages are present on the second coil portion 522b of the second winding 522, and a voltage tolerance capability of the second coil portion 522b of the second winding 522 is increased.

In the exemplary embodiment, the second coil portion 522b of the second winding 522 and the first winding 521 are disposed in a side-by-side structure, the first coil portion 522a of the second winding 522 and the first winding 521 are disposed in a layered structure. That is, the transformer 50 comprises the side-by-side structure and the layered structure. In the side-by-side structure, the magnetic field of the first winding 521 is not fully coupled to the second coil portion 522b of the second winding 522. Thus, a larger leakage inductance is generated, for example: 10 mH. While in the layered structure, the magnetic field of first winding 521 is fully coupled to the first coil portion 522a of the second winding 522. Thus, a smaller leakage inductance is generated, for example: 2 mH. Consequently, the leakage inductance of the transformer 50 in accordance with the present invention is between 2 mH and 10 mH.

In the exemplary embodiment, the number of coils of the first coil portion 522a and the second coil portion 522b of the second winding 522 is adjustable, thus, the leakage inductance of the transformer 50 is also adjustable.

When the number of coils of the first winding 521 is fixed, and the total number of coils of the first coil portion 522a and the second coil portion 522b of the second winding 522 are also fixed, if the number of coils of the second coil portion 522b of the second winding 522 is greater than that of the first coil portion 522a of the second winding 522, the leakage inductances of the side-by-side structure and the layered structure are increased. Thus, the leakage inductance of the transformer 50 is also increased. Coils may be left off the first coil portion 522a of the second winding 522 to obtain a conventional side-by-side structure only.

Contrarily, if the number of coils of the second coil portion 522b of the second winding 522 is less than that of the first coil portion 522a, the leakage inductances of the side-by-side structure and the layered structure are decreased. Thus, the leakage inductance of the transformer 50 is also decreased. Coils may be left off the second coil portion 522b to obtain a conventional layered structure.

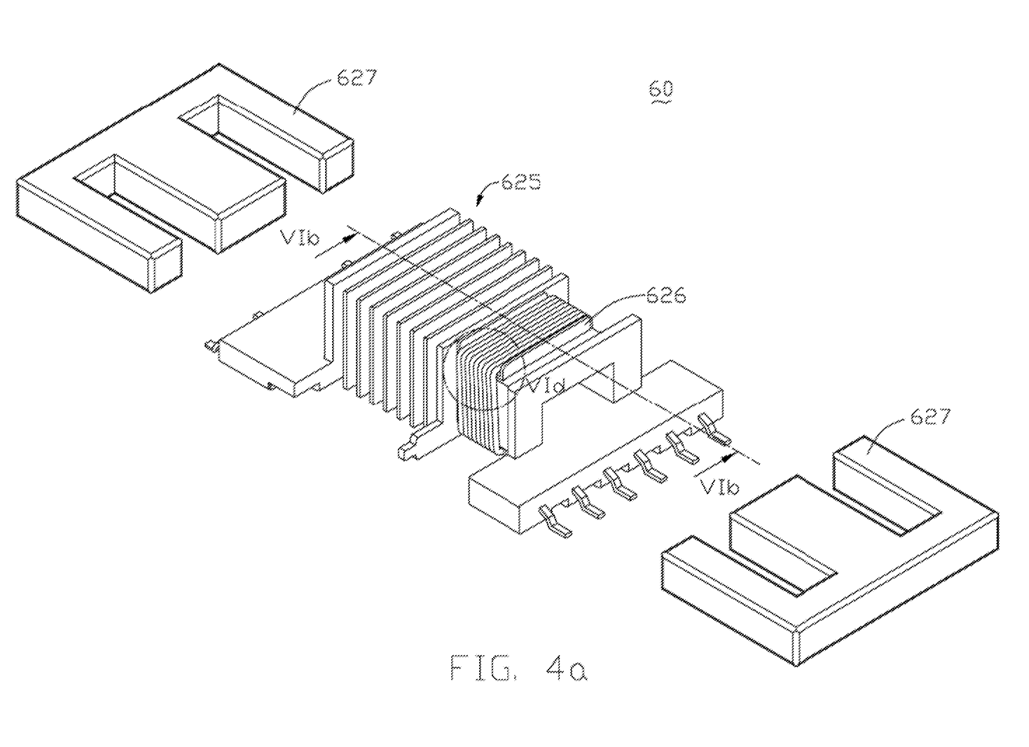

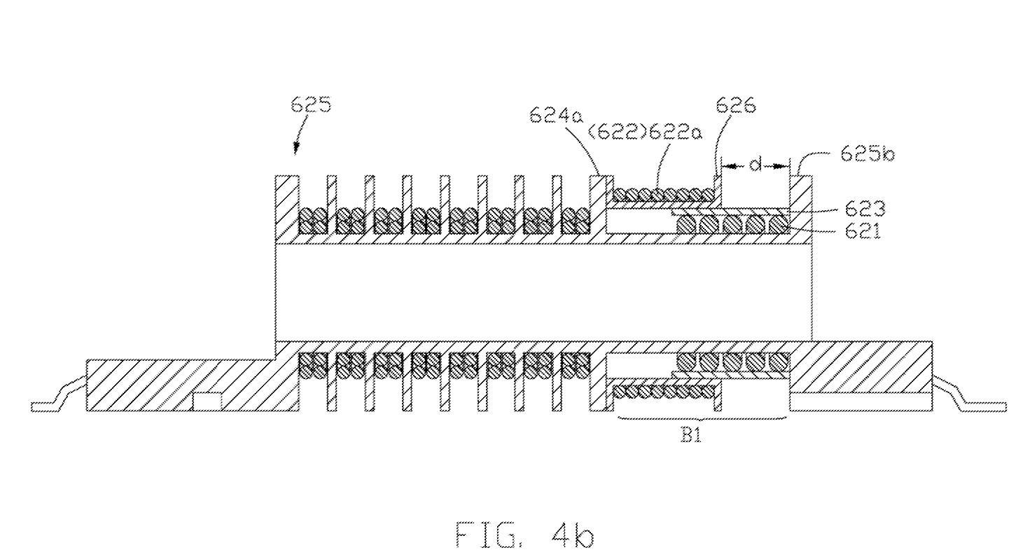

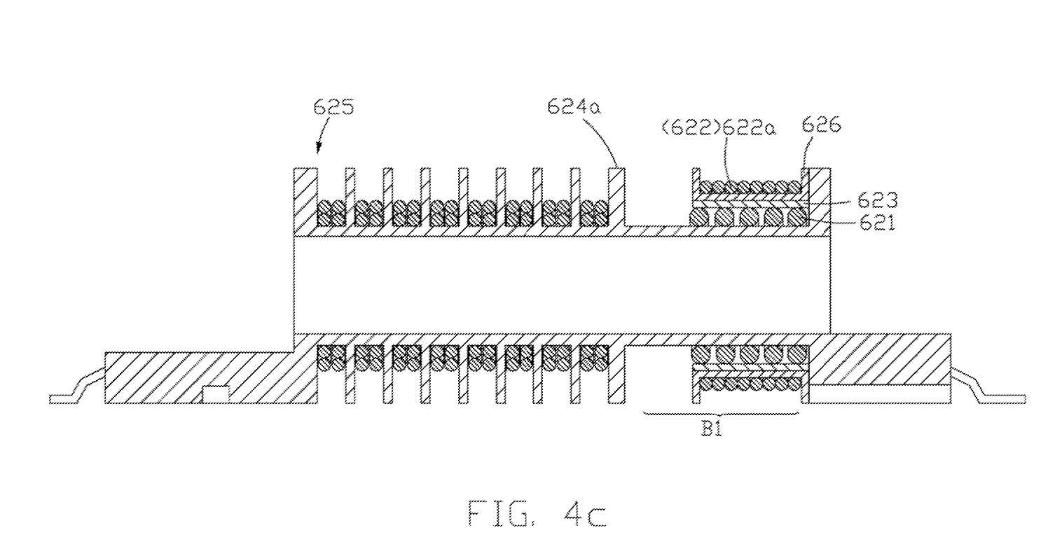

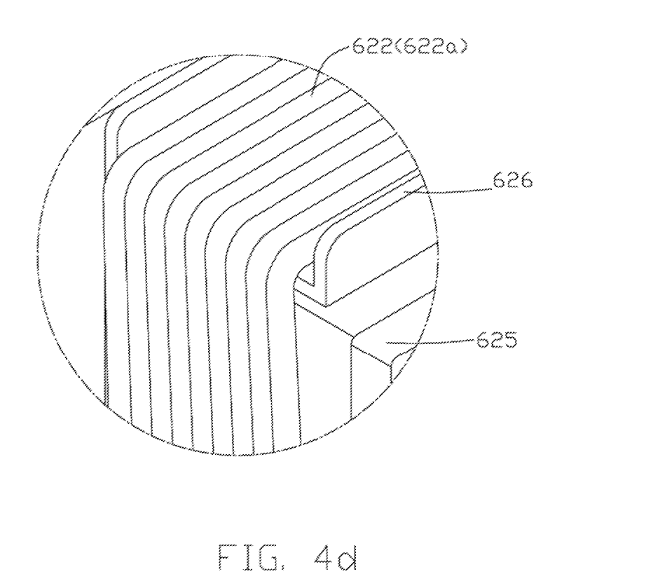

In the exemplary embodiment, the first winding 521 wound around the first region B1 of the bobbin 525 is a primary winding, which is connected to the driving switch circuit 31 or 41 shown in FIG. 3 or FIG. 4. The second winding 522 is a secondary winding, which is connected to the light source module 33 or 43 as shown in FIG. 3 or FIG. 4. In addition, the number of coils of the first winding 521 is less than that of the second winding 522. When a voltage is provided to the first winding 521, a magnetic field produced by current flowing through the first winding 521 cuts the second winding 522. Thus, a high voltage is generated on the second winding 522. The leakage inductance and a leakage capacitor (not shown) of the transformer 50 form a resonance circuit, converting the high voltage to the appropriate AC signal to drive the light sources.

FIG. 4a shows an isometric, disassembled view of a transformer 60 with an adjustable leakage inductance in accordance with a second embodiment of the present invention. The transformer 60 has a similar structure to that of the transformer 50 shown in FIG. 4a, except that the transformer 60 includes a first bobbin 625 and at least one second bobbin 626. The second bobbin 626 is movable along an axis of the first bobbin 625, for adjusting the leakage inductance of the transformer 60.

FIG. 4b and FIG. 4c show a cross-sectional view along line VIb-VIb of FIG. 4a. In the exemplary embodiment, the transformer 60 shown in FIG. 4b has a larger leakage inductance than as it is shown in FIG. 4c. The structures of FIG. 4b and FIG. 4c are substantially the same as that of FIG. 3b, except for the addition of the at least one second bobbin and that the first region B1 of the first bobbin 625 is only partially covered by the first winding 621. Further, a length of the second bobbin 626 is less than that of the first region B1 of the first bobbin 625. Consequently, the second bobbin 626 is moveable along the axis of the first bobbin 625, for adjusting the leakage inductance of the transformer 60.

In the exemplary embodiment, when the second bobbin 626 is near to the isolating wall 624a as shown in FIG. 4b, the magnetic field of the first winding 621 is not fully coupled to the first coil portion 622a of the second bobbin 626. That is, the magnetic field in a region ‘d’ of the first winding 621 is not coupled to the first coil portion 622a of the second bobbin 626, which forms a leakage magnetic flux, and generates a leakage inductance. In addition, when there is little or no gap between the second bobbin 626 and the isolating wall 624a, the coupling ratio is low, and the leakage inductance of the transformer 60 is high.

Contrarily, when the second bobbin 626 is far from the isolating wall 624a as shown in FIG. 4c, the magnetic field of the first winding 621 is fully coupled to the first coil portion 622a of the second bobbin 626. In addition, a gap exists between the second bobbin 626 and the isolating wall 624a, thus the coupling ratio is high, and the leakage inductance of the transformer 60 is low.

Consequently, even though the number of coils of the first winding 621 and the second winding 622 of the transformer 60 are fixed, the coupling ratio between the first coil portion 622a of the second winding 622 and the first winding 621 is adjustable via adjusting the position of the second bobbin 626 along the axis of the first bobbin 625, thereby adjusting the leakage inductance of the transformer 60.

FIG. 4d shows a partially enlarged view along VId of FIG. 4a. In the exemplary embodiment, there are two second bobbins 626 (FIG. 4d shows one second bobbin 626), arranged in parallel at opposite sides of the first region (not shown) of the first bobbin 625, for winding of the first coil portion 622a of the second winding 622 therearound.

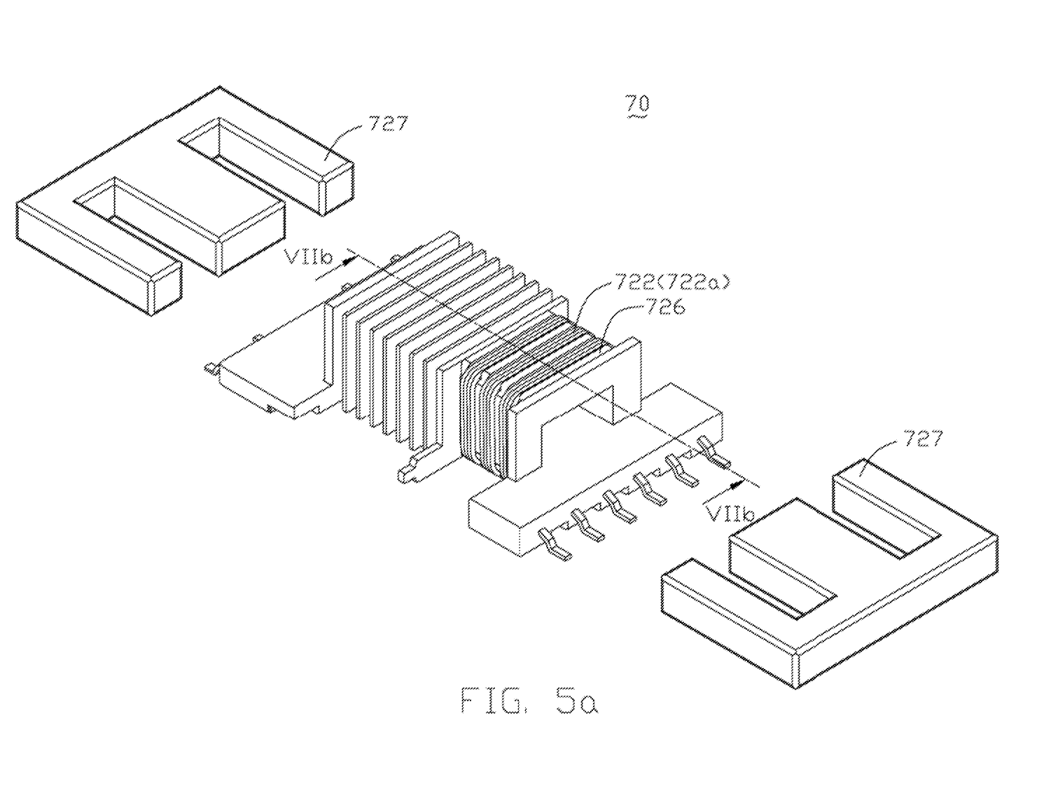

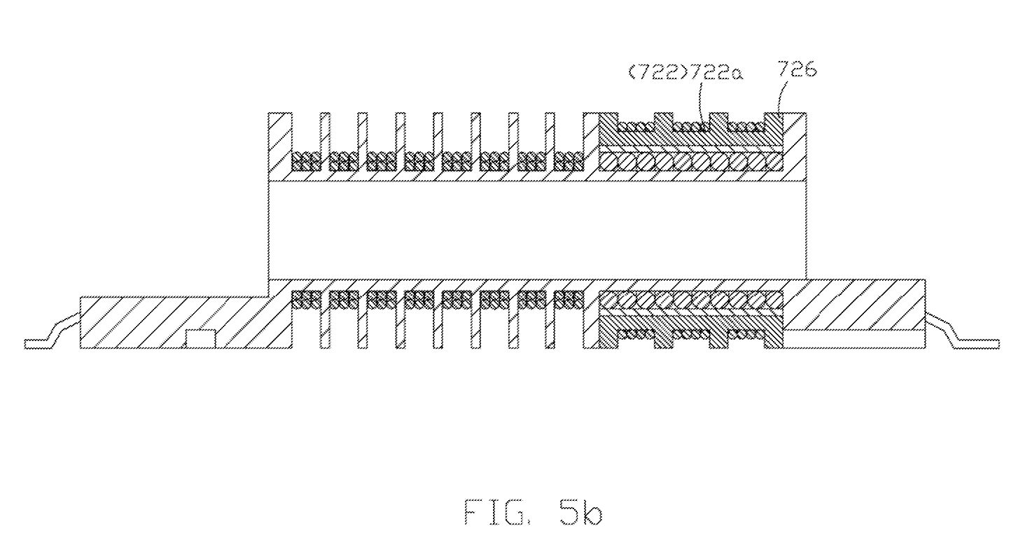

FIG. 5a shows an isometric, disassembled view of a transformer 70 with an adjustable leakage inductance in accordance with a third embodiment of the present invention, and FIG. 5b shows a cross-sectional view along line VIIb-VIIb of FIG. 5a. The transformer 70 has a similar structure to that of the transformer 50 as shown in FIG. 3a, except that the transformer 70 includes a pair of second bobbins 726 with a plurality of coiling regions, for increasing voltage tolerances of the first coil portion 722a of the second winding 722 to avoid arcing.

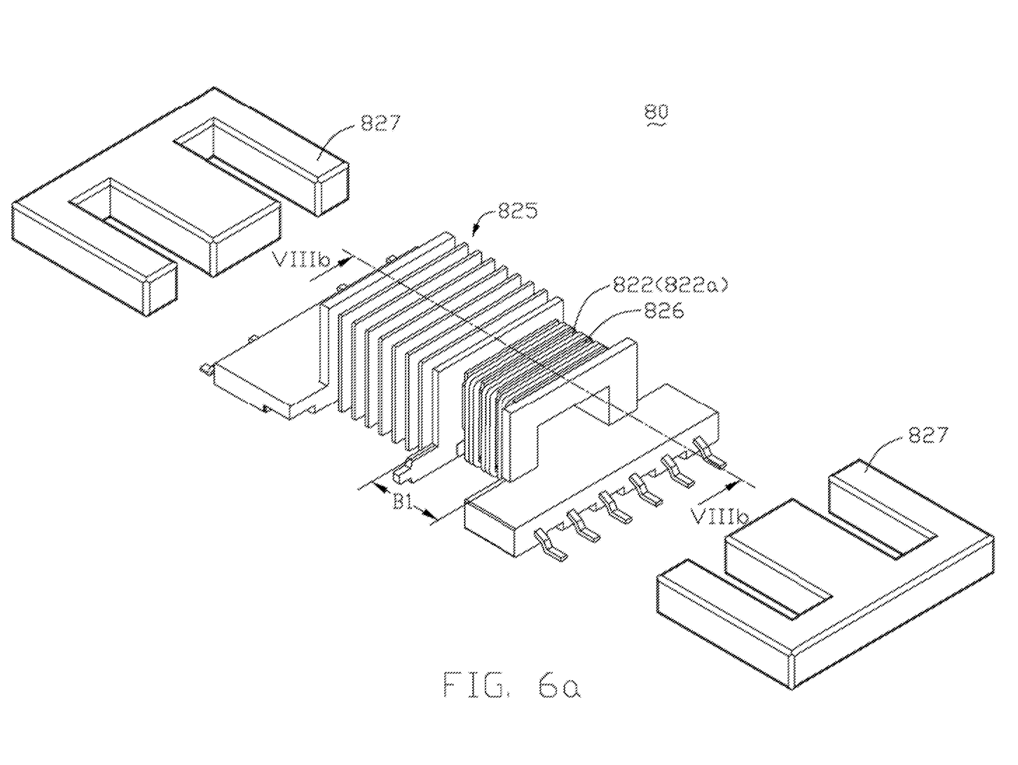

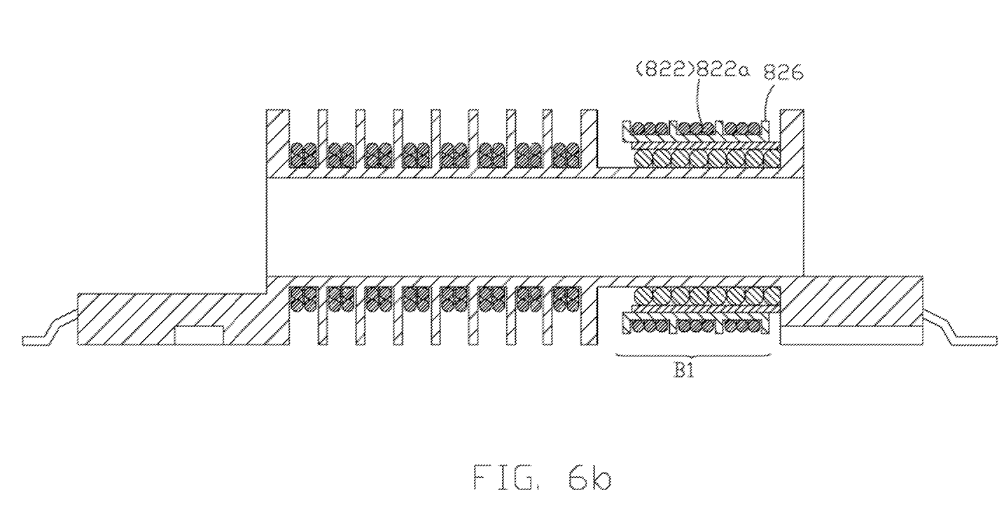

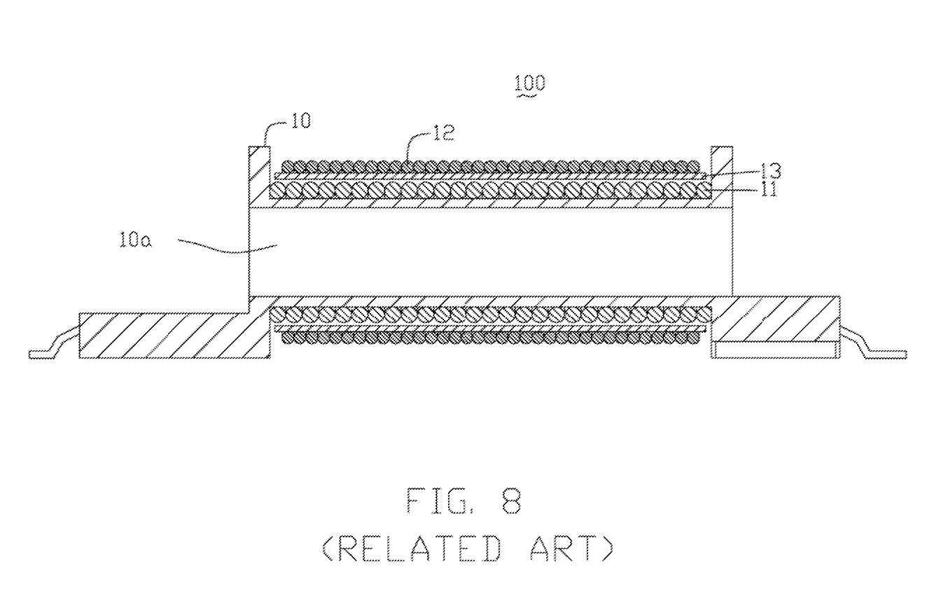

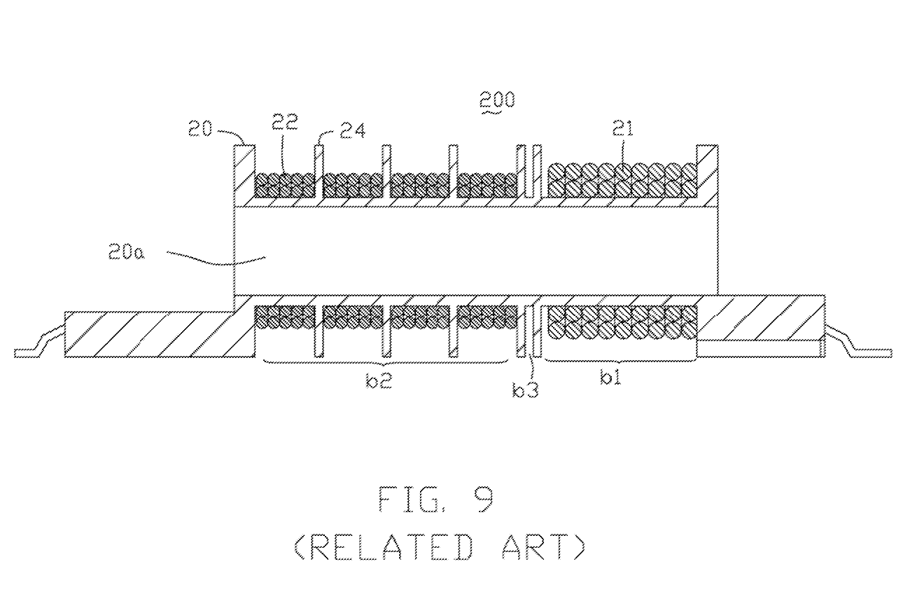

FIG. 6a shows an isometric, disassembled view of a transformer 80 with an adjustable leakage inductance in accordance with a fourth embodiment of the present invention, and FIG. 6b shows a cross-sectional view along line VIIIb-VIIIb of FIG. 6a. The transformer 80 has a similar structure to that of the transformer 60 of FIG. 4b, except that the second bobbin 826 of FIG. 8a includes a plurality of coiling regions, for increasing voltage tolerances of the first coil portion 822a of the second winding 822 to avoid arcing. The second bobbin 826 is also movable along the axis of the first bobbin 825, for adjusting the leakage inductance of the transformer 80.

Similarly, in the exemplary embodiment, leakage inductance of the transformer 80 is adjusted through positioning of the movable second bobbin 826.

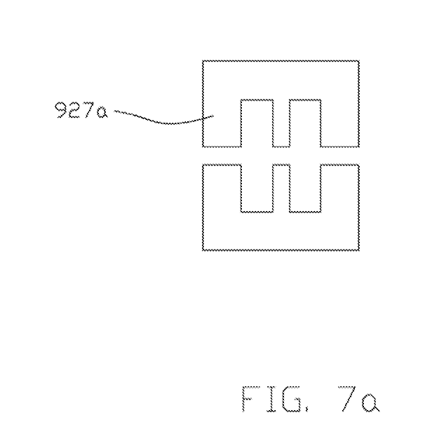

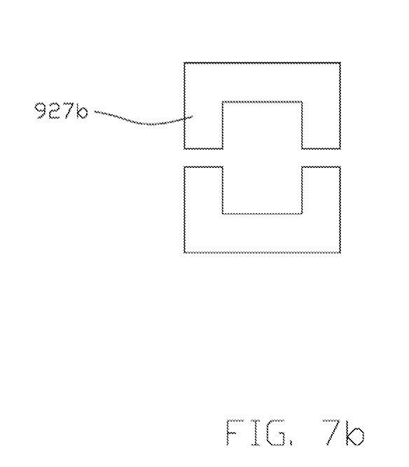

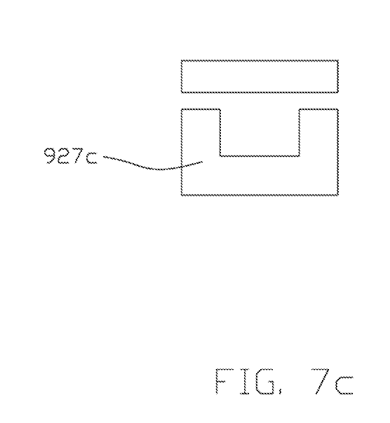

FIG. 7a shows an elevational view of a core assembly as used for core assemblies 527, 627, 727, and 827 of transformers 50, 60, 70, and 80 in accordance with the present invention. The core assembly, in accordance with the present invention, can be EE shaped 927a. In alternative exemplary embodiments, the core assembly can be UU shaped 927b or UI shaped 927c as depicted FIGS. 7b and 7c or other shapes as determined by need.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalent.

What is claimed is:

1. A transformer with an adjustable leakage inductance, comprising:
a first bobbin, comprising a first region and a second region;
a first winding; and
a second winding, comprising a first coil portion and a second coil portion;
wherein one of the first winding and the first coil portion of the second winding is wound around the first region of the first bobbin, and the other of the first winding and the first coil portion of the second winding is wound outside of the one wound around the first region of the first bobbin, and the second coil portion of the second winding is wound around the second region of the first bobbin.

2. The transformer as claimed in claim 1, wherein the number of coils of the first coil portion and/or the second coil portion of the second winding is adjustable.

3. The transformer as claimed in claim 1, further comprising at least one second bobbin for supporting the first coil portion of the second winding.

4. The transformer as claimed in claim 3, wherein the at least one second bobbin is two, arranged in parallel at opposite sides of the first bobbin.

5. The transformer as claimed in claim 3, wherein at least one second bobbin comprises a plurality of coiling regions.

6. The transformer as claimed in claim 3, wherein a length of the at least one second bobbin is shorter than that of the first region of the first bobbin, wherein the first winding is partially wound around the first region of the first bobbin.

7. The transformer as claimed in claim 6, wherein the second bobbin is movable along an axis of the first bobbin, for adjusting the leakage inductance.

8. The transformer as claimed in claim 1, further comprising an insulating layer disposed between the first winding and the first coil portion of the second winding.

9. The transformer as claimed in claim 8, further comprising at least a pair of margin tapes, wound around the insulating layer.

10. A driving device for driving a light source module comprising a plurality of lamps, comprising:
a converter circuit, for converting a received power signal to a direct current signal;
a driving switch circuit, connected to the converter circuit, for converting the direct current signal to an alternating current signal;
a transformer circuit, connected between the driving switch circuit and the light source module, for converting the alternating current signal to an appropriate alternating current signal, wherein the transformer circuit comprises a transformer with an adjustable leakage inductance, comprising:
a first bobbin, comprising a first region and a second region;
a first winding; and
a second winding, comprising a first coil portion and a second coil portion;
wherein one of the first winding and the first coil portion of the second winding is wound around the first region of the first bobbin, and the other of the first winding and the first coil portion of the second winding is wound outside of the one wound around the first region of the first bobbin, and the second coil portion of the second winding is wound around the second region of the first bobbin; and
a PWM controller, connected to the driving switch circuit, for controlling the alternating current signal output from the driving switch circuit.

11. The driving device as claimed in claim 10, wherein the number of coils of the first coil portion and/or the second coil portion of the second winding is adjustable.

12. The driving device as claimed in claim 10, wherein the transformer further comprises at least one second bobbin for supporting the first coil portion of the second winding.

13. The driving device as claimed in claim 12, wherein the at least one second bobbin is two, arranged in parallel at opposite sides of the first bobbin.

14. The driving device as claimed in claim 12, wherein at least one second bobbin comprises a plurality of coiling regions.

15. The driving device as claimed in claim 12, wherein a length of the at least one second bobbin is shorter than that of the first region of the first bobbin, wherein the first winding is partially wound around the first region of the first bobbin.

16. The driving device as claimed in claim 15, wherein the second bobbin is movable along an axis of the first bobbin, for adjusting the leakage inductance.

17. The driving device as claimed in claim 10, further comprising an insulating layer disposed between the first winding and the first coil portion of the second winding.

18. The driving device as claimed in claim 17, further comprising at least a pair of margin tapes, wound around the insulating layer.

19. A driving device for driving a light source module, comprising:
a converter circuit for converting a received power signal to a direct current signal;
a driving switch circuit electrically connectable with said converter circuit for converting said direct current signal to an alternating current signal;
a transformer circuit electrically connectable between said driving switch circuit and a light source module for converting said alternating current signal to an appropriate alternating current signal so as to drive said light source module via said appropriate alternating current signal, said transformer circuit comprising a transformer having a bobbin defining a first region and a second region thereon, a first winding wound in said first region of said bobbin, a part of a second winding wound in said second region of said bobbin and another part of said second winding wound in said first region to overlap with said first winding; and
a PWM controller electrically connectable with said driving switch circuit for controlling said alternating current signal output from said driving switch circuit.

20. The driving device as claimed in claim 19, wherein said first winding is selective to entirely overlap with said another part of said second winding and to partially overlap with said another part of said second winding.
